(19) United States
(12) Patent Application Publication
(10) Pub. No.: US 2006/0288757 A1
(43) Pub. Date: Dec. 28, 2006

(54) Crimp contact and gas sensor

(75) Inventors: Hisaharu Nishio, Aichi (JP); Yoshiaki Matsubara, Nagoya (JP); Noboru Ishida, Gifu (JP); Masaaki Murase, Aichi (JP); Masahiro Asai, Nagoya (JP); Makoto Hishiki, Aichi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 11/474,949

(22) Filed: Jun. 27, 2006

(30) Foreign Application Priority Data
Jun. 27, 2005 (JP) 2005-186081

(51) Int. Cl. G01N 35/00

(52) U.S. Cl. 73/1.02; 428/929

(57) ABSTRACT

A crimp contact includes a wire hold portion crimped onto and holding therein core wires of an electrical lead. The wire hold portion has a bottom wall and a pair of side walls bent in such a manner as to bring ends of the side walls into contact with each other to define a wire accommodation space and satisfies the following equations: {(W1−W2)/2}/W3≦1.2 and H2/H1>0.5 where W1 is a maximum width of the wire hold portion; W2 is a maximum width of the wire accommodation space; W3 is a minimum thickness of the bottom wall; H1 is a maximum thickness of the wire hold portion; and H2 is a maximum distance from an outermost point of the side wall to a tip point of the side wall end along a thickness direction of the wire hold portion.

### BACKGROUND OF THE INVENTION

The present invention relates to a crimp contact and a gas sensor. Hereinafter, the term “front” refers to a sensing end side with respect to an axial direction of the gas sensor, and the term “rear” refers to a side opposite to the front side.

Japanese Laid-Open Patent Publication No. 64-041184 discloses one conventional type of crimp contact that has wire hold portions extending axially and holding therein core wires of an electrical lead. The crimp contact is suitably used for e.g. a gas sensor in an automotive exhaust system to connect the electrical lead wire with a sensor element of the gas sensor for signal output from the sensor element to an external device.

### SUMMARY OF THE INVENTION

In order for the gas sensor to secure accurate signal output over a long period of time, it is desirable that the wire hold portions of the crimp contact hold the lead core wires tightly so as to prevent or minimize a widening of clearance between the wire hold portions and the lead core wires and avoid an increase in electrical resistance between the crimp contact and the electrical lead during the heating and cooling cycles of operation of the gas sensor.

In the above-mentioned conventional crimp contact, however, the wire hold portions are simply crimped onto the lead core wires with no specific dimension control through the application of a lubricant and thus may not be able to hold the lead core wires sufficiently tightly. It is further difficult in the conventional crimp contact to bend the wire hold portions adequately during the crimping process depending on the crimping process conditions (where the use of the lubricant is impractical in view of the crimp contact quality) and the crimp contact material so that the wire hold portions cannot hold the lead core wires tightly. As a result, there often arises an increase in electrical resistance between the conventional crimp contact and the electrical lead during the heating and cooling cycles of operation. The gas sensor with such a conventional crimp contact fails to secure accurate signal output over a long period of time.

It is therefore an object of the present invention to provide a crimp contact capable of holding an electrical lead wire tightly and securely, regardless of the crimping process conditions (the use or disuse of a lubricant in the crimping process) and the crimp contact material, without causing an increase in electrical resistance between the crimp contact and the lead wire even when subjected to loads of the heating/cooling cycle operation.

It is also an object of the present invention to provide a gas sensor having such a crimp contact to secure accurate signal output over a long period of time.

According to a first aspect of the present invention, there is provided a crimp contact comprising a wire hold portion extending in an axial direction thereof and holding therein core wires of an electrical lead, the wire hold portion having, when viewed in cross section perpendicular to the axial direction, a bottom wall and a pair of side walls rising from opposite sides of the bottom wall and bent in such a manner as to turn top ends of the respective side walls toward the bottom wall and bring the top ends of the side walls into contact with each other to define a wire accommodation space in which the lead core wires are enclosed by the bottom wall and the side walls, and the wire hold portion being configured to satisfy the following equations: {(W1−W2)/2}/W3≦1.2; and H2/H1>0.5 where W1 is a maximum width of the wire hold portion; W2 is a maximum width of the wire accommodation space; W3 is a minimum thickness of the bottom wall; H1 is a maximum thickness of the wire hold portion; and H2 is a maximum distance from an outermost point of the side wall to a tip point of the top end of the side wall along a thickness direction of the wire hold portion.

According to a second aspect of the present invention, there is provided a crimp contact comprising a wire hold portion extending in an axial direction thereof and holding therein core wires of an electrical lead, the wire hold portion having, when viewed in cross section perpendicular to the axial direction, a bottom wall and a pair of side walls rising from opposite sides of the bottom wall, with top ends of the respective side walls previously inclined toward each other, and bent in such a manner as to turn the previously inclined top ends of the side walls toward the bottom wall and bring one of the previously inclined top ends of the side walls into contact with the other of the previously top ends of the side walls to define a wire accommodation space in which the lead core wires are enclosed by the bottom wall and the side walls.

According to a third aspect of the present invention, there is provided a gas sensor comprising: a cylindrical metallic housing; a sensor element disposed in the housing with at least a sensor portion of the sensor element protruding from a front end of the housing; a protective cover attached to a rear end of the housing; an electrical lead extending within the protective cover to produce a signal output from the sensor element to an external device; and a crimp contact connecting the a front end of electrical lead to a terminal portion of the sensor element, the crimp contact having a wire hold portion extending in an axial direction thereof and holding therein core wires of the electrical lead, the wire hold portion having, when viewed in cross section perpendicular to the axial direction, a bottom wall and a pair of side walls rising from opposite sides of the bottom wall and bent in such a manner as to turn top ends of the respective side walls toward the bottom wall and bring the top ends of the side walls into contact with each other to define a wire accommodation space in which the lead core wires are enclosed by the bottom wall and the side walls, and the wire hold portion being configured to satisfy the following equations: {(W1−W2)/2}/W3≦1.2; and H2/H1≧0.5 where W1 is a maximum width of the wire hold portion; W2 is a maximum width of the wire accommodation space; W3 is a minimum thickness of the bottom wall; H1 is a maximum thickness of the wire hold portion; and H2 is a maximum distance from an outermost point of the side wall to a tip point of the top end of the side wall along a thickness direction of the wire hold portion.

According to a fourth aspect of the present invention, there is provided a gas sensor comprising: a cylindrical metallic housing; a sensor element disposed in the housing with at least a sensor portion of the sensor element protruding from a front end of the housing; a protective cover attached to a rear end of the housing; an electrical lead extending within the protective cover to produce a signal output from the sensor element to an external device; and a crimp contact connecting a front end of the electrical lead to a terminal portion of the sensor element, the crimp contact having a wire hold portion extending in an axial direction thereof and holding therein core wires of the electrical lead, and the wire hold portion having, when viewed in cross section perpendicular to the axial direction, a bottom wall and a pair of side walls rising from opposite sides of the bottom wall, with top ends of the respective side walls previously inclined toward each other, and bent in such a manner as to turn the previously inclined top ends of the side walls toward the bottom wall and bring one of the previously inclined top ends of the side walls into contact with the other of the previously inclined top ends of the side walls to define a wire accommodation space in which the lead core wires are enclosed by the bottom wall and the side walls.

The other objects and features of the invention will also become understood from the following description.

### BRIEF DESCRIPTION OF THE DRAWINGS

FIG. 1 is a sectional view of a gas sensor according to one exemplary embodiment of the present invention.

FIG. 2 is a perspective view of a crimp contact formed with wire hold portions, before being crimped onto the core wires of an electrical lead, according to a first or second embodiment of the present invention.

FIG. 3A is a sectional view of the wire hold portion of the crimp contact, before being crimped onto the lead core wires, according to the first embodiment of the present invention.

FIG. 3B is a sectional view of the wire hold portion of the crimp contact, before being crimped onto the lead core wires, according to the second embodiment of the present invention.

FIG. 4 is a schematic view of how to attach the crimp contact onto the electrical lead according to the first or second embodiment of the present invention.

FIG. 5 is a perspective view of a joint between the crimp contact and the electrical lead according to the first or second embodiment of the present invention.

FIG. 6 is a sectional view of the joint between the crimp contact and the electrical lead according to the first embodiment of the present invention.

FIG. 7 is a sectional view of the joint between the crimp contact and the electrical lead according to the second embodiment of the present invention.

### DESCRIPTION OF THE EMBODIMENTS

The present invention will be described below in detail with reference to the following first and second embodiments, in which like parts and portions are designated by like reference numerals.

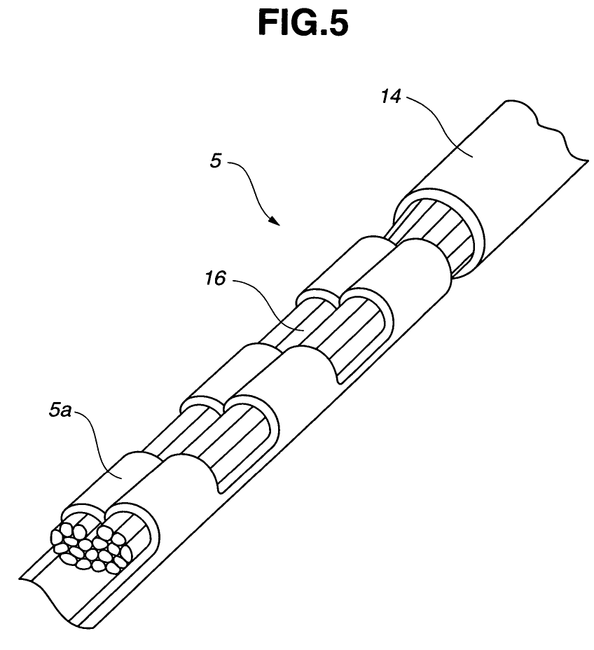

Referring to FIG. 5, the first and second embodiments provide crimp contacts 5, each of which has one or more, e.g., three wire hold portions 5a extending axially and crimped to hold therein a plurality of, e.g., nineteen metal core wires 16 of an electrical lead 14.

The wire hold portions 5a can be made of various metal materials such as a stainless alloy, nickel-chromium-iron alloy e.g. Inconel, beryllium copper alloy, copper-titanium alloy and copper-nickel-tin alloy. When there is a demand for heat resistance, the wire hold portions 5a may be suitably made of Inconel. The lead core wires 16 can be made of copper, tungsten, a tungsten-rhenium alloy and a mixture of silicon nitride or tungsten carbide. In the first and second embodiments, the lead core wires 16 are 0.2 mm in diameter.

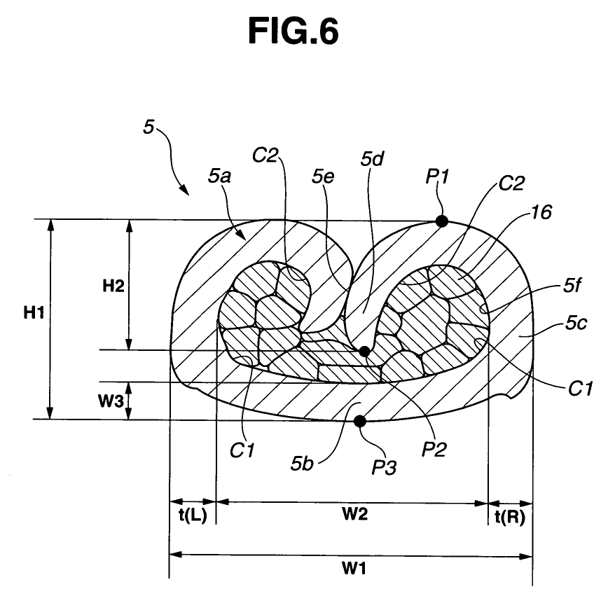

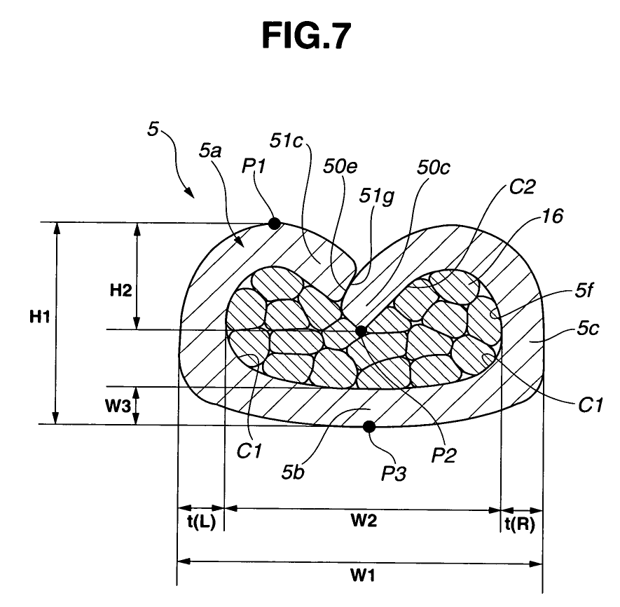

As shown in FIGS. 6 and 7, each of the wire hold portions 5a includes, when viewed in cross section perpendicular to the axial direction, a bottom wall 5b and a pair of side walls 5c rising from opposite sides of the bottom wall 5b and bent along an arcs in such a manner that the side walls 5c have their respective top ends 5d or 50c and 51c (located opposite to the bottom wall 5b) turned toward the bottom wall 5b and brought into contact with each other to form a wire accommodation space 5f in which the lead core wires 16 are enclosed by the bottom wall 5b and the side walls 5c. More specifically, in the first embodiment, outer surfaces 5e of the side wall ends 5d (other than end faces of the side wall ends 5d and inner surfaces of the side wall ends 5d defining a part of the wire accommodation space 15f) are brought into contact with each other as shown in FIG. 6. In the second embodiment, by contrast, an end face 51g of the side wall end 51c is brought into contact with an outer surface 50e of the side wall end 50c as shown in FIG. 7.

In both of the first and second embodiments, the dimensions of the wire hold portion 5a are controlled to satisfy the following equations (1) and (2):
{(W1−W2)/2}/W3≦1.2 (1)
H2/H1≧0.5 (2)
where W1 is a maximum width of the wire hold portion 5a; W2 is a maximum width of the wire accommodation space 5f; W3 is a minimum thickness of the bottom wall 5b; H1 is a maximum thickness of the wire hold portion 5a, i.e. a maximum distance between an outermost (starting) point P1 of the side wall 5c and an outermost (starting) point P3 of the bottom wall 5b; and H2 is a maximum distance from the outermost point P1 of the side wall 5c to a tip point P2 of the side wall end 5d, 50c or 51c along a thickness direction of the wire hold portion 5a.

Herein, the maximum width W1 and the maximum width W2 indicate maximum horizontal dimensions when the wire hold portion 5a is viewed in cross section perpendicular to the axial direction with the bottom wall 5b placed in a horizontal orientation. The minimum thickness W3 indicates a minimum vertical dimension when the wire hold portion 5a is viewed in cross section perpendicular to the axial direction with the bottom wall 5b placed in a horizontal orientation. Further, the maximum thickness (distance) H1 and the maximum distance H2 indicate maximum vertical dimensions when the wire hold portion 5a is viewed in cross section perpendicular to the axial direction with the bottom wall 5b placed in a horizontal orientation.

When the equation (1) is satisfied, the thickness of the bottom wall 5b is sufficiently large with respect to the thickness t(L), t(R) of the side walls 5c so that both of the side walls 5c properly rise from the bottom wall 5b. The side walls 5c are bent deeply so that the side wall ends 5d or 50c and 51c get sufficiently close to the bottom wall 5b when the equation (2) is satisfied. With such a configuration, the wire hold portion 5a becomes able to limit displacements of the lead core wires 16 relative to the wire accommodation space 5f and to hold the lead core wires 16 tightly and securely by the bottom wall 5b and the side walls 5c regardless of the use or disuse of a lubricant in the crimping process and the kind of material of the crimp contact 5. It is therefore possible to prevent or minimize a widening of clearance between the wire hold portion 5a and the lead core wires 16 and avoid an increase in electrical resistance between the crimp contact 5 and the electrical lead 14 during the heating and cooling cycles of operation.

Preferably, the dimensions of the wire hold portion 5a are controlled to satisfy the following equation (3):
1<{(W1−W2)/2}/W3 (3).
When the equation (3) is satisfied, the wire hold portion 5a becomes placed under a higher load to hold the lead core wires 16 more tightly and securely by the bottom and side walls 5b and 5c.

It is preferable that, as is the case with the first embodiment, the outer surfaces 5e of the respective side wall ends 5d are brought into contact with each other. With this configuration, the side wall ends 5d get closer to the bottom wall 5c. The wire hold portion 5a becomes thus able to hold the lead core wires 16 more tightly and securely by the bottom and side walls 5b and 5c without causing an increase in electrical resistance during the heating and cooling cycles of operation. It is noted that, in the first embodiment, the side wall ends 5d face the bottom wall 5b but are not in contact with the bottom wall 5b such that some of the lead core wires 16 exist between the bottom wall 5b and the side wall ends 15d.

It is also preferable that each of the inner surfaces of the bottom wall 5b and the side walls 5c (especially, the inner boundary surfaces C1 between the bottom wall 5b and the side walls 5c and the inner surfaces C2 of the side wall ends 5d or 50c and 51c) is curved with a certain radius of curvature R so as to prevent or minimize a widening of clearance between the bottom and side walls 5b and 5c and the lead core wires 16. In order to prevent or minimize clearance between the bottom and side walls 5b and 5c and the lead core wires 16 without fail, the curvature radius R is preferably made greater than or equal to the wire diameter of the lead core wires 16 as measured before the crimping process. This allows the wire hold portion 5a to hold the lead core wires 16 tightly and securely without causing an increase in electrical resistance during the heating and cooling cycles of operation.

It is further preferable to crimp the wire hold portion 5a onto the lead core wires 16 in such a manner that all of the lead core wires 16 become deformed to change in dimension by 5% or more (i.e. the maximum wire diameter of the lead core wires 16 increases by 5% or more, or the minimum wire diameter of the lead wire cores 16 decreases by 5% or more). This allows the wire hold portion 5a to hold the lead core wires 16 more tightly and securely.

The above crimp contact 5 can be provided as follows in each of the first and second embodiments.

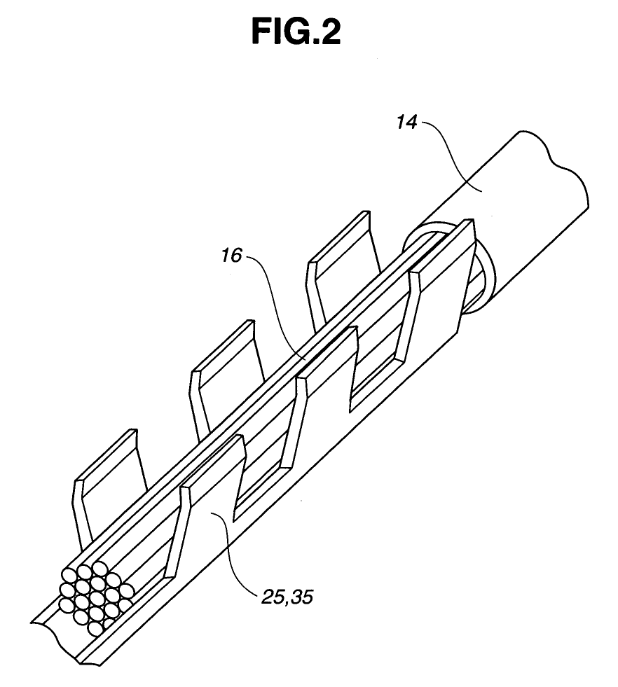

As shown in FIG. 2, the crimp contact 5 is first prepared with uncrimped wire hold portions 25, 35 (to be completed into the respective wire hold portions 5a during the subsequent crimping process).

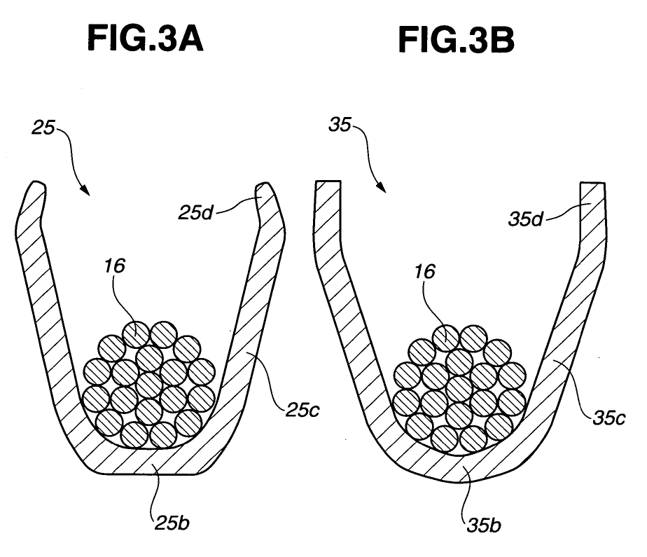

In the first embodiment, each of the uncrimped wire hold portions 25 extends axially and includes, when viewed in cross section perpendicular to the axial direction, a bottom wall 25b and a pair of side walls 25c rising from opposite sides of the bottom wall 25b as shown in FIG. 3A. Top end regions 25d of the side walls 25c (to be formed into the side wall ends 5d) are previously inclined toward each other and made smaller in thickness than the other regions of the side walls 25c. The end regions 25d of the side walls 25c have respective tip points with a thickness of 0.1 mm (smaller than the diameter of the lead core wires 16) whereas the bottom wall 25b and the other regions of the side walls 25c have a thickness of 0.2 mm in the first embodiment.

In the second embodiment, each of the uncrimped wire hold portions 35 extends axially and includes, when viewed in cross section perpendicular to the axial direction, a bottom wall 35b and a pair of side walls 35c rising from opposite sides of the bottom wall 35b as shown in FIG. 3B. Top end regions 35d of the side walls 35c (to be formed into the side wall ends 50c and 51c) are held substantially in parallel to each other and made substantially equal in thickness to the other regions of the side walls 35c. All of the bottom wall 35b and the side walls 35c (including their respective end regions 35d) are 0.2 mm in thickness in the second embodiment.

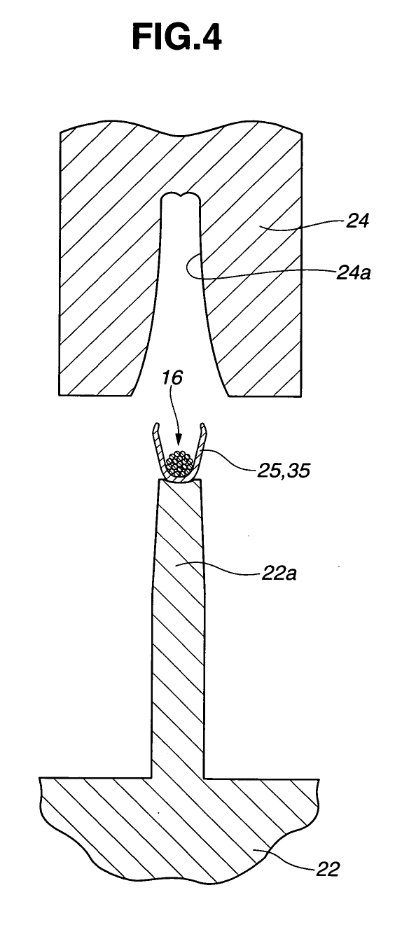

As shown in FIG. 4, the wire hold portions 25, 35 are crimped onto the lead core wires 16 using an anvil 22 and a crimper 24. The anvil 22 has a protrusion 22a extending upwardly from its bottom base, whereas the crimper 24 has a recess 24a formed in its bottom end surface to engage with the anvil protrusion 22a. The crimping process is thus performed by arranging the wire hold portions 25, 35 on a top surface of the anvil protrusion 22a, placing the lead core wires 16 in the wire hold portions 25, 35 so as to surround the lead core wires 16 by the bottom walls 25b, 35b and the side walls 25c, 35c, moving the crimper 24 down to the anvil 22 and then pressing the wire hold portions 25, 35 between the anvil protrusion 22a and the crimper recess 24a. The crimp contact 5 is then completed.

When the side wall end regions 25d are inclined toward each other as is the case of the first embodiment, the sidewall end regions 25d can be easily guided by the crimper 24 closer to each other and be turned deeply toward the bottom wall 25b in the crimping process. Further, the side wall end regions 25d can be turned more deeply toward the bottom wall 25b in the crimping process when the side wall end regions 25d are made thinner as is the case of the first embodiment. The completed wire hold portion 5a becomes thus able to hold the lead core wires 16 more tightly and securely by the bottom wall 5b and the side walls 5c in the first embodiment regardless of the use or disuse of lubricant in the crimping process and the kind of material of the crimp contact 5.

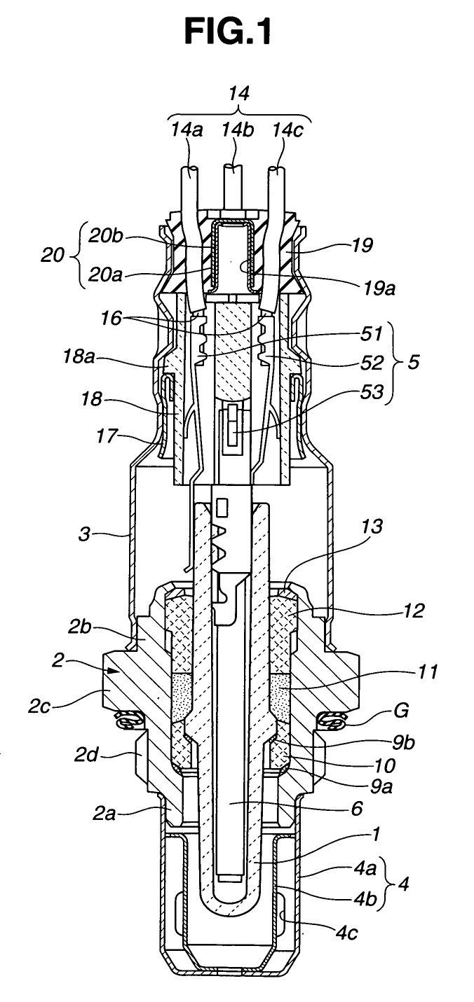

The above-configured crimp contacts 5 are applicable to various uses such as a gas sensor as shown in FIG. 1. By way of example, the gas sensor is herein designed for use in an automotive exhaust system to detect the concentration of a specific gas component such as oxygen in automotive exhaust gas (as measurement gas).

The gas sensor generally includes a sensor element 1, a heater element 6, a metallic sensor housing 2, metallic protective covers 3 and 4, metal packings 9a and 9b, a ceramic holder 10, a sealing power material 11 (of e.g. talc), a ceramic sleeve 12, a metal ring 13, a separator holder 17, a ceramic separator 18, a rubber grommet 19 and a filter unit 20 in addition to the crimp contacts 5 and the electrical leads 14 (hereinafter occasionally referred to as “crimp contacts 51, 52 and 53” and “electrical leads 14a, 14b and 14c, respectively).

The sensor element 1 and the heater element 6 are arranged axially in the sensor housing 2.

The sensor housing 2 is formed into a cylindrical shape to accommodate therein the sensor element 1 with a front end portion (sensor portion) of the sensor element 1 protruding from a front end of the sensor housing 2. A rear end of the sensor housing 2 is radially inwardly caulked so that the sensor element 1 is retained insulatively in the sensor housing 2 via the metal packings 9a and 9b, the ceramic holder 10, the sealing power material 11, the ceramic sleeve 12 and the metal ring 13. The sensor housing 2 has cylindrical bosses 2a and 2b formed on front and rear end portions of the sensor housing 2, respectively, a flange portion 2c formed between the bosses 2a and 2b and a male thread portion 2d formed between the boss 2a and the flange portion 2c. Further, a gasket G is fitted around the sensor housing 2 at a location between the flange portion 2c and the male thread portion 2d.

The protective cover 3 is fixed at a front end thereof to the boss 2b of the sensor housing 2 so as to enclose and protect rear end portions (terminal portions) of the sensor element 1 and the heater element 6 protruding from the rear end of the sensor housing 2, the crimp contacts 51, 52 and 53 and the core wires 16 of the electrical leads 14a, 14b and 14c.

The protective cover 4 has an outer cover member 4a fixed at a rear end thereof to an outer surface of the boss 2a of the sensor housing 2 and an inner cover member 4b fixed in the outer cover member 4a so as to enclose and protect the sensor portion of the sensor element 1. Gas holes 4c are formed in the cover members 4a and 4b, respectively, so that the measurement gas flows to the sensor portion of the sensor element 1 through the gas holes 4c (although the gas hole 4c in the inner cover member 4b is not shown in the drawings.)

The ceramic separator 18 is provided with a flange portion 18a and arranged in a middle portion of the protective cover 3 with the separator holder 17 disposed between the protective cover 3 and the separator 18 at a front side of the separator flange portion 18a.

The grommet 19 is formed into an annular shape with a through hole 19a and fixed in a rear portion of the protective cover 3 adjacently to the separator 18.

The filter unit 20 is fitted in the grommet through hole 19a and has a metal cylindrical filter holder 20a and a filter 20b held by cylindrical and end surfaces of the holder 20a so as to provide gas communication between the inside of the protective cover 3 and the outside of the gas sensor via the filter 20b. The filter 20b can be made of e.g. polytetrafluoroethylene (PTFE).

The electrical leads 14a, 14b and 14c are passed through the grommet 19 for connection of the sensor element 1 and the heater element 6 to an external device.

The crimp contacts 51, 52 and 53 have front ends electrically connected to the terminal portions of the sensor element 1 and the heater element 6 within a front portion of the protective cover 3 and rear ends formed with the wire hold portions 5a and electrically connected to the core wires 16 of the electrical leads 14a, 14b and 14c within the separator 18, thereby allowing signal output from the sensor element 1 to the external device and energization of the heater element 6.

As explained above, the crimp contacts 5 (51, 52, 53) are able to hold the lead core wires 16 tightly and securely without an increase in electrical resistance during the heating and cooling cycles of operation. With the use of such crimp contacts 5 (51, 52, 53) in the gas sensor, it becomes possible for the gas sensor to secure accurate signal output from the sensor element 1 to the external device as well as proper energization of the heater element 6 over a long period of time even when subjected to loads of the heating/cooling cycle operation of the gas sensor.

The present invention will be described in more detail by reference to the following examples. It should be however noted that the following examples are only illustrative and not intended to limit the invention thereto.

### EXAMPLE 1

Test samples of crimp contacts 5 of the first embodiment were prepared, each of which had three wire hold portions 5a crimped onto nineteen lead core wires 16 as shown in FIG. 5. The wire hold portions 5a were herein made of Inconel. The lead core wires 16 were made of pure copper and had a diameter of 0.2 mm before the crimping process. The crimping process was performed using an anvil 22 and a crimper 24 as shown in FIG. 4 without the application of a lubricant. Each of the completed wire hold portions 5a had a bottom wall 5b and side walls 5c, with top ends 5d of the respective side walls 5c turned toward the bottom wall 5b and outer surfaces 5e of the respective side wall ends 5d brought in contact with each other, to enclose the lead core wires 16 in a wire accommodation space 5f as shown in FIG. 6.

For cross section observation of the wire hold portion 5a, one of the test samples of the crimp contacts 5 was cut at a joint between the wire hold portion 5a and the lead core wires 16 along a direction perpendicular to an axial direction of the wire hold portion 5a.

Various dimension measurements were made on the cross section of the wire hold portion 5a, so as to determine a maximum width W1 of the wire hold portion 5a, a maximum width W2 of the wire accommodation space 5f, a minimum thickness W3 of the bottom wall 5b, a thickness t(R) of the right side wall 5c along an extension line of the width W2, a thickness t(L) of the left side wall 5c along an extension line of the width W2, a maximum thickness H1 of the wire hold portion 5a and a maximum distance H2 from an outermost top point P1 of the side wall 5c to a tip point P2 of the side wall end 5d along a thickness direction of the wire hold portion 5a as indicated in FIG. 6. The dimensional ratios of {(W1−W2)/2}/W3 and H2/H1 were calculated from these measurement values W1, W2, W3, H1 and H2. The measurement and calculation results are shown in TABLE.

The curvature radii R of inner surfaces of the bottom and side walls 5b and 5c and the maximum diameters of the lead core wires 16 were also determined by observation of the cross section of the wire hold portion 5a. Each of the inner surfaces of the bottom wall 5b and the side walls 5c (especially, the inner boundary surfaces C1 between the bottom wall 5b and the side walls 5c and the inner surfaces C2 of the side wall ends 5d) had a curvature radius R of 0.2 mm or larger, i.e., greater than or equal to the diameter of the lead core wires 16 as measured before the crimping process. Further, all of the lead core wires 16 had been deformed and had a maximum diameter of 0.21 mm or larger after the crimping process to show a change in dimension by 5% or more.

The other test samples of the crimp contacts 5 were tested for electrical resistance (Ω) before and after performing 1000 cycles of heating at 300° C. for 20 minutes and cooling at room temperatures for 10 minutes. The incidence of resistance increase was evaluated by 100×A/N (%) where A is the number of the test samples in which the electrical resistance increased by 1Ω or more during the heating and cooling cycles of operation; and N is the total number of the test samples. The evaluation result is also shown in TABLE.

### EXAMPLE 2

Test samples of crimp contacts 5 of the second embodiment were prepared, each of which had three wire hold portions 5a crimped onto nineteen lead core wires 16 as shown in FIG. 5. The wire hold portions 5a were made of Inconel. The lead core wires 16 were made of pure copper and had a diameter of 0.2 mm before the crimping process. The crimping process was performed using an anvil 22 and a crimper 24 as shown in FIG. 4 without the application of a lubricant. Each of the completed wire hold portions 5a had a bottom wall 5b and side walls 5c, with top ends 50c and 51c of the respective side walls 5c turned toward the bottom wall 5b and an end face 51g of the side wall end 51c brought in contact with an outer surface 50e of the side wall end 50c, to enclose the lead core wires 16 in a wire accommodation space 5f as shown in FIG. 7.

One of the test samples of the crimp contacts 5 was cut at a joint between the wire hold portion 5a and the lead core wires 16 along a direction perpendicular to an axial direction of the wire hold portion 5a for observation of the cross section of the wire hold portion 5a.

Various dimensions W1, W2, W3, t(L), t(R), H1 and H2 were measured as indicated in FIG. 7, and then, the dimensional ratios of {(W1−W2)/2}/W3 and H2/H1 were calculated from these measurement values W1, W2, W3, H1 and H2. The measurement and calculation results are shown in TABLE.

The curvature radii R of inner surfaces of the bottom and side walls 5b and 5c and the maximum diameters of the lead core wires 16 were also determined by observation of the cross section of the wire hold portion 5a. Each of the inner surfaces of the bottom wall 5b and the side walls 5c (especially, the inner boundary surfaces C1 between the bottom wall 5b and the side walls 5c and the inner surfaces C2 of the side wall ends 50c and 51c) had a curvature radius R of 0.2 mm or larger, i.e., greater than or equal to the diameter of the lead core wires 16 as measured before the crimping process. Further, all of the lead core wires 16 had been deformed and had a maximum diameter of 0.21 mm or larger after the crimping process to show a change in dimension by 5% or more.

The other test samples of the crimp contacts 5 were tested for electrical resistance before and after performing 1000 cycles of heating at 300° C. for 20 minutes and cooling at room temperatures for 10 minutes, to evaluate the incidence of resistance increase by 100×A/N (%) where A is the number of the test samples in which the electrical resistance increased by 1 Ω or more during the heating and cooling cycles of operation; and N is the total number of the test samples. The evaluation result is also shown in TABLE.

### COMPARATIVE EXAMPLE

Test samples of crimp contacts were prepared in the same way as in Examples 1 and 2, except that each wire hold portion had a bottom wall and side walls crimped onto lead core wires with top end faces of the respective side walls brought into contact with each other. Then, dimension measurements, dimensional ratio calculations and resistance increase incidence evaluation were made on the test samples in the same way as in Examples 1 and 2. The measurement, calculation and evaluation results are shown in TABLE.

TABLE

| | | | | | | | | | | Incidence of |
|---|---|---|---|---|---|---|---|---|---|---|
| | W1 | W2 | W3 | t(L) | t(R) | | H1 | H2 | | resistance |
| | (mm) | (mm) | (mm) | (mm) | (mm) | {(W1 − W2)/2}/W3 | (mm) | (mm) | H2/H1 | increase (%) |
| Example 1 | 1.791 | 1.366 | 0.189 | 0.207 | 0.206 | 1.122 | 1.019 | 0.681 | 0.668 | 0.0 |
| Example 2 | 1.780 | 1.330 | 0.197 | 0.213 | 0.214 | 1.141 | 0.999 | 0.510 | 0.510 | 13.3 |
| Comparative | 1.783 | 1.314 | 0.188 | 0.226 | 0.226 | 1.245 | 1.013 | 0.406 | 0.400 | 80.0 |
| Example | | | | | | | | | | |

As is evident from TABLE, the incident of resistance increase was much lower in each of Examples 1 and 2 than in Comparative Example.

It has thus been shown that each of the wire hold portions 5a of the crimp contacts 5 of the first and second embodiments, which satisfies the equations of {(W1−W2)/2}/W3≦1.2 and H2/H1≧0.5, is capable of holding the lead core wires 16 tightly and securely under uniform and adequate loads to prevent or minimize a widening of clearance between the wire hold portion 5a and the lead core wires 16 and avoid an increase in electrical resistance during the heating and cooling cycles of operation and, in particular, the configuration of the wire hold portions 5a in which the outer end surfaces 5e of the side walls 5c are held into contact with each other as in the crimp contact 5 of the first embodiment provides a large effect in preventing increases in electrical resistance.

The entire contents of Japanese Patent Application No. 2005-186081 (filed on Jun. 27, 2005) are herein incorporated by reference.

Although the present invention has been described with reference to the first and second specific embodiments of the invention, the invention is not limited to the above-described embodiments. Various modification and variation of the embodiments described above will occur to those skilled in the art in light of the above teaching. For example, the number of wire hold portions 5a in each crimp contact 5 is not limited to three although the crimp contact 5 is provided with three wire hold portions 5a in the first and second embodiments. The crimp contact 5 may alternatively be provided with one, two, or more than three wire hold portions 5a. Generally, the crimp contact 5 can hold the lead core wires 16 securely when provided with a plurality of wire hold portions 5a. The scope of the invention is defined with reference to the following claims.

What is claimed is:

1. A crimp contact comprising a wire hold portion extending in an axial direction thereof and holding therein core wires of an electrical lead,
the wire hold portion having, when viewed in cross section perpendicular to the axial direction, a bottom wall and a pair of side walls rising from opposite sides of the bottom wall and bent in such a manner as to turn top ends of the respective side walls toward the bottom wall and bring the top ends of the side walls into contact with each other to define a wire accommodation space in which the lead core wires are enclosed by the bottom wall and the side walls, and the wire hold portion being configured to satisfy the following equations:
{(W1−W2)/2}/W3≦1.2; and
H2/H1≧0.5
where W1 is a maximum width of the wire hold portion; W2 is a maximum width of the wire accommodation space; W3 is a minimum thickness of the bottom wall; H1 is a maximum thickness of the wire hold portion; and H2 is a maximum distance from an outermost point of the side wall to a tip point of the top end of the side wall along a thickness direction of the wire hold portion.

2. The crimp contact according to claim 1, wherein the wire hold portion is configured to satisfy the following equation: 1<{(W1−W2)/2}/W3.

3. The crimp contact according to claim 1, wherein the ends of the side walls have respective outer surfaces held into contact with each other.

4. The crimp contact according to claim 1, wherein each of the bottom wall and the side walls has an inner surface curved with a radius of curvature.

5. The crimp contact according to claim 4, wherein said radius of the curvature is greater than or equal to a diameter of the lead core wires as measured before the wire hold portion is crimped onto the lead core wires.

6. The crimp contact according to claim 1, wherein the wire hold portion is crimped onto the lead core wires in such a manner that all of the lead core wires become deformed to change in dimension by 5% or more.

7. A crimp contact comprising a wire hold portion extending in an axial direction thereof and holding therein core wires of an electrical lead,
the wire hold portion having, when viewed in cross section perpendicular to the axial direction, a bottom wall and a pair of side walls rising from opposite sides of the bottom wall, with top ends of the respective side walls previously inclined toward each other, and bent in such a manner as to turn the previously inclined top ends of the side walls toward the bottom wall and bring one of the previously inclined top ends of the side walls into contact with the other of the previously top ends of the side walls to define a wire accommodation space in which the lead core wires are enclosed by the bottom wall and the side walls.

8. The crimp contact according to claim 7, wherein the ends of the side walls have respective outer surfaces held into contact with each other.

9. The crimp contact according to claim 7, wherein the ends of the side walls are thinner than any other regions of the side walls.

10. The crimp contact according to claim 7, wherein each of the bottom wall and the side walls has an inner surface curved with a radius of curvature.

11. The crimp contact according to claim 10, wherein said radius of curvature is greater than or equal to a diameter of the lead core wires as measured before the wire hold portion is crimped onto the lead core wires.

12. The crimp contact according to claim 7, wherein the wire hold portion is crimped onto the lead core wires in such a manner that all of the lead core wires become deformed to change in dimension by 5% or more.

13. A gas sensor comprising:
a cylindrical metallic housing;
a sensor element disposed in the housing with at least a sensor portion of the sensor element protruding from a front end of the housing;
a protective cover attached to a rear end of the housing;
an electrical lead extending within the protective cover to produce a signal output from the sensor element to an external device; and
a crimp contact connecting a front end of the electrical lead to a terminal portion of the sensor element,
the crimp contact having a wire hold portion extending in an axial direction thereof and holding therein core wires of the electrical lead,
the wire hold portion having, when viewed in cross section perpendicular to the axial direction, a bottom wall and a pair of side walls rising from opposite sides of the bottom wall and bent in such a manner as to turn top ends of the respective side walls toward the bottom wall and bring the top ends of the side walls into contact with each other to define a wire accommodation space in which the lead core wires are enclosed by the bottom wall and the side walls, and the wire hold portion being configured to satisfy the following equations:
{(W1−W2)/2}/W3≦1.2; and
H2/H1≧0.5
where W1 is a maximum width of the wire hold portion; W2 is a maximum width of the wire accommodation space; W3 is a minimum thickness of the bottom wall; H1 is a maximum thickness of the wire hold portion; and H2 is a maximum distance from an outermost point of the side wall to a tip point of the top end of the side wall along a thickness direction of the wire hold portion.

14. A gas sensor comprising:
a cylindrical metallic housing;
a sensor element disposed in the housing with at least a sensor portion of the sensor element protruding from a front end of the housing;
a protective cover attached to a rear end of the housing;
an electrical lead extending within the protective cover to produce a signal output from the sensor element to an external device; and
a crimp contact connecting a front end of the electrical lead to a terminal portion of the sensor element,
the crimp contact having a wire hold portion extending in an axial direction thereof and holding therein core wires of the electrical lead, and
the wire hold portion having, when viewed in cross section perpendicular to the axial direction, a bottom wall and a pair of side walls rising from opposite sides of the bottom wall, with top ends of the respective side walls previously inclined toward each other, and bent in such a manner as to turn the previously inclined top ends of the side walls toward the bottom wall and bring one of the previously inclined top ends of the side walls into contact with the other of the previously inclined top ends of the side walls to define a wire accommodation space in which the lead core wires are enclosed by the bottom wall and the side walls.
